(19) United States
(12) Patent Application Publication
(10) Pub. No.: US 2006/0179437 A1
(43) Pub. Date: Aug. 10, 2006

(54) System and method for managing a predetermined hierarchical set of autonomous and dependent operations in a user interface

(76) Inventors: Anh Hong, San Jose, CA (US); Laura Katherine Coster Stewart, San Jose, CA (US); Mark Forrest Taylor, Mountain View, CA (US); Mary Trombley, Campbell, CA (US)

Correspondence Address: SAMUEL A. KASSATLY LAW OFFICE, 20690 VIEW OAKS WAY, SAN JOSE, CA, 95120, US

(21) Appl. No.: 11/051,685

(22) Filed: Feb. 4, 2005

(51) Int. Cl. G06F 9/46

(52) U.S. Cl. 718/104

(57) ABSTRACT

A sequential task execution system manages and relates a predetermined hierarchical set of autonomous and dependent operations in a user interface. The system comprises a graphical user interface. Given a set of autonomous operations executed in sequence to complete a task, the present system steps a user through the sequential operations. At each step in the sequence, the present system searches an application space to determine whether the step has previously been executed. If the step has not been previously executed, the present system executes the step. If the step has been previously executed, the present system allows the user to either select results from the previous execution or execute the step “on demand”. The system further allows interruption and resumption of operation at the interruption step.

### FIELD OF THE INVENTION

The present invention generally relates to software programs. More particularly, the present invention pertains to a system and method for performing a sequential set of operations in which a step may require completion of a previous step. The present invention further pertains to a system and method for performing a sequential set of operations in which a user may select a result of a previously executed operation in lieu of any applicable step in the sequential set of operations.

### BACKGROUND OF THE INVENTION

In using or operating a software program, a user is often required to perform configuration tasks or build an environment through the use of abstract objects. Instructions and guidance to the user for completing these tasks are typically provided through a “wizard” or a “launchpad” using a graphical user interface (GUI).

A wizard comprises an interface that guides a user through a sequence of operations to achieve one task, prompting the user for input on each operation. The operations are not executed or committed until the user has provided input for each operation and has initiated execution by, for example, selecting a “finish” button. A typical wizard bundles all operations into a single, autonomous operation. Although this technology has proven to be useful, it would be desirable to present additional improvements. A wizard requires a user to start from an assumed, predetermined environment each time the wizard is implemented even though portions of the sequence of operations may have already been performed.

The launchpad comprises an interface that provides a listing of all operations necessary for completing a task, listed in the order in which the operations are to be executed. Each operation is executed immediately after the user has provided any required input and has approved execution of the operation. If operations have been completed in a previous session, the user may select the next operation in the sequence of operations. Although this technology has proven to be useful, it would be desirable to present additional improvements.

A launchpad has no knowledge of operations that have been completed in a previous session. Objects created in a sequence of operations may depend on the creation of an object in a previous operation. However, the launchpad has no means for knowing or indicating whether the required object exists before attempting to create an object in a current operation. When operations are dependent on previously executed operations, the launchpad can negate work that has already been performed.

An environment such as a database comprises objects such as tables, views, etc. Generating an application solution often requires generating objects in a sequence in which some of the objects depend on existence of other objects. Sequential generation of the objects can be described as a hierarchy of objects in which each object created in the sequence may be autonomous (independent) or dependent (a child of a previously created object).

Neither a wizard approach nor a launchpad approach can determine whether objects that may be used in following the sequential generation of objects exist and can be used. Furthermore, neither conventional approach can create the hierarchy of objects within a desired context. The desired context comprises an object or objects previously created that are required to create the desired object or hierarchy of objects.

For example, an object called a “nickname” is used as a pointer to remote objects by an information integrator in a database such as DB2®. Nicknames are part of the DB2® catalog. A server definition is required before a nickname can be created. A wrapper is required before a server definition is created. Generation of a wrapper requires configuration of the client with which the wrapper communicates. Existence of each of these objects (the client configuration, the wrapper, and the server definition) is required to create the nicknames. A user wishes to create a nickname, but does not know if the objects required for creation of the nickname exist. Each of the objects required for creation of the nickname is created by an autonomous action; however, within a sequence of operations in creating the nickname, creation or selection of the objects occurs within a hierarchy. This hierarchy may use existing objects or create a new object, depending on the nickname the user is attempting to create. Each object within the hierarchy of objects is created within the context of previously selected or created objects.

Presently, there exists no method for generating an object from a sequence of operations in which each object is created within a context of a hierarchy of objects. What is needed is a method that is able to either find an object to be used in the sequence of operations or create the object in the desired sequence within the context of a previously created or selected object. What is therefore needed is a system, a computer program product, and an associated method for managing and relating a predetermined hierarchical set of autonomous and dependent operations in a user interface. The need for such a solution has heretofore remained unsatisfied.

### SUMMARY OF THE INVENTION

The present invention satisfies this need, and presents a system, a computer program product, and an associated method (collectively referred to herein as “the system” or “the present system”) for managing and relating a predetermined hierarchical set of autonomous and dependent operations in a user interface. The present system executes dependent operations autonomously in a predetermined sequence. Moreover, the present system can take advantage of a previous execution of one or more of the operations in the predetermined sequence or perform an operation in the predetermined sequence “on demand” by the user.

The present system is a tool comprising a graphical user interface. Given a set of autonomous operations executed in sequence to complete a task, the present system steps a user through the sequential operations. At each step in the sequence, the present system searches an application space to determine whether the step has previously been executed. If the step has not been previously executed, the present system executes the step. If the step has been previously executed, the present system allows the user to either select results from the previous execution or execute the step “on demand,” i.e., as demanded or requested by the user.

The present system gives the user an opportunity of leveraging any previous execution of a step, using results from the previous execution of the step to proceed to the next operation in the sequence. Consequently, a user can decrease the number of operations needed to complete a task by taking advantage of previously executed operations. Furthermore, the user maintains the flexibility of executing all operations in the sequence if desired.

The present system allows a user to interrupt execution of the predetermined sequence of operations. The user may resume the predetermined sequence at any time. At each previously executed step in the predetermined sequence, the present system allows the user to either select the previously created or found object or create a new object, as desired.

Alternatively, the user may skip one or more steps in the predetermined sequence, resuming the operation of the present system at the previously interrupted step by using previously created resources.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a sequential task execution system of the present invention can be used;

FIG. 2 represents a process flow chart illustrating a method of operation of the sequential task execution system of FIG. 1; and

FIG. 3 represents a schematic illustration of a screen shot portraying a step in a predetermined hierarchical sequence of the sequential task execution system of FIG. 1;

### DETAILED DESCRIPTION OF PREFERRED EMBODIMENTS

The following definitions and explanations provide background information pertaining to the technical field of the present invention, and are intended to facilitate the understanding of the present invention without limiting its scope:

Autonomous: referring to a process that can be performed independently or an object that can exist independent of other objects yet can be performed by the present system within a context of a hierarchical sequence of steps.

Dependent: referring to a process or an object requiring the a priori existence of an object or the prior execution of a process before the object can be created or the process executed.

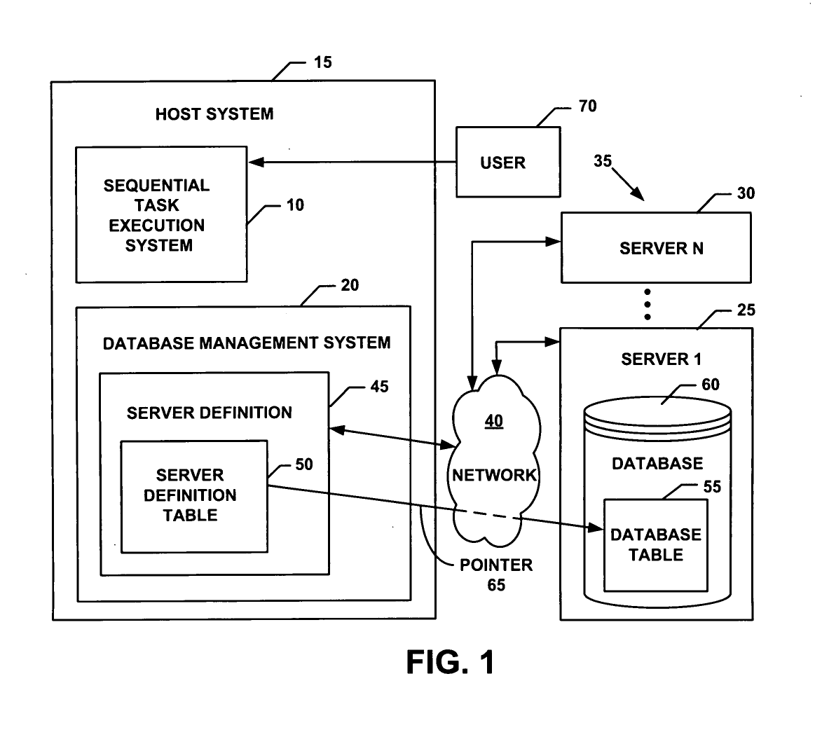

FIG. 1 portrays an exemplary overall environment in which a system and associated method for relating a set of autonomous and dependent operations in a user interface (the “sequential task execution system 10” or “system 10”) according to the present invention may be used. System 10 comprises a software programming code or a computer program product that is typically embedded within, or installed on a host system 15. Alternatively, system 10 can be saved on a suitable storage medium such as a diskette, a CD, a hard drive, or like devices.

The host system comprises a database management system (DBMS) 20. The DBMS 20 comprises metadata in the form of catalogs. These catalogs describe objects such as tables and views. Objects may be known within the DBMS 20 that refer to objects outside the host system 15. These objects outside the host system 15 reside on servers such as server 1, 25, through server N, 30, collectively referenced as servers 35. The host server 15 communicates with servers 35 through a network 40. While more than one server is shown in FIG. 1, the host system 15 may connect to only one server.

An exemplary object known to the DBMS 20 is a server definition 45 that comprises a server definition table 50. The server definition 45 is an object that is defined in a database catalog by metadata; the server definition 45 points to a server such as the server 1, 25. The server definition 45 connects through the network 40 to the servers 35. The server definition table 50 references a database (dB) table 55 on a database (dB) 60 through a pointer 65.

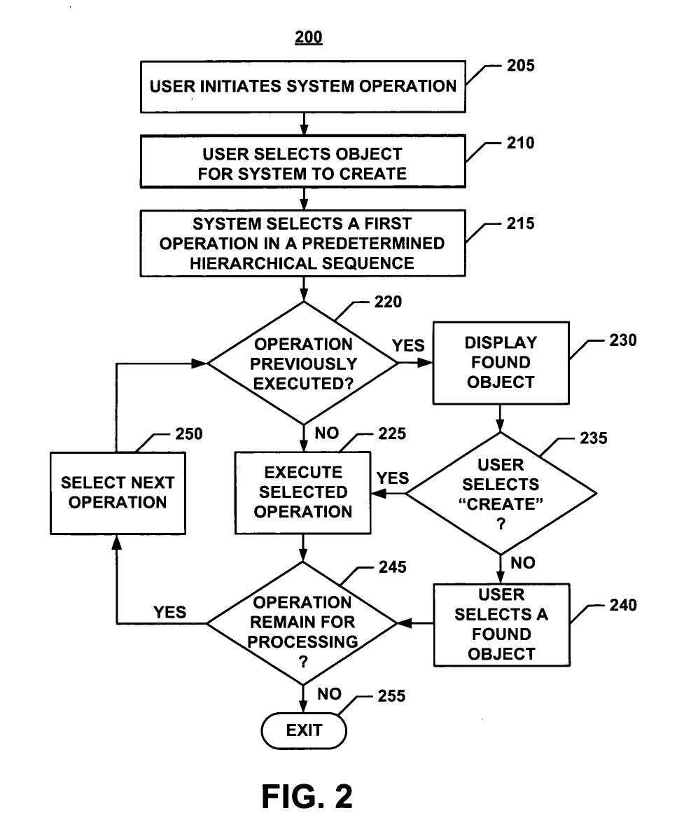

With further reference to FIG. 1, FIG. 2 illustrates a method 200 of operation of system 10 in generating an exemplary object requiring a sequential hierarchy of n objects. While described in terms of an object such as, for example, a nickname, system 10 may be used to generate any form of resource.

A user 70 initiates operation of system 10 (step 205). User 70 initiates operation of system 10 through a graphical user interface of system 10. User 70 selects an object for creation by system 10 (step 210). System 10 selects a first operation in a predetermined hierarchical sequence of operations (step 215).

System 10 determines whether the selected operation has previously been executed (decision step 220). If the selected operation has not been previously executed (i.e., no object is found corresponding to the selected operation), system executes the selected operation (step 225). If the selected operation has previously been executed, an object has been found corresponding to the selected operation. System 10 displays the found object(s) to user 70 (step 230). User 70 may choose to create a new object by selecting a “create” button or function (decision step 235); system 10 then executes the selected operation (step 225). Otherwise (at decision step 235), user 70 selects a found object from the list of found objects (step 240).

System 10 determines whether additional operations remain for processing in the predetermined hierarchical sequence of operations (decision step 245). If additional operations remain, system 10 selects the next operation in the predetermined hierarchical sequence of operations (step 250), iteratively repeating step 220 through step 245. Otherwise (at decision step 245), no additional operations remain to be executed and system 10 exits method 200 (step 255).

The following pseudocode further illustrates the operation of system 10 in the predetermined hierarchical sequence of n operations:

Operation 1.
If operation 1 executed previously {

Retrieve required resources
if resources selected

proceed to operation 2

else

execute operation 1

else

execute operation 1

proceed to operation 2

Operation 2.
If operation 2 executed previously {

Retrieve required resources
if resources selected

proceed to operation 3

else

execute operation 2

else

execute operation 2

proceed to operation 3

. . .
Operation N.
If operation N executed previously {

Retrieve required resources
if resources selected

complete task

else

execute operation N

else

execute operation N

compete task

Operation 2 is an operation immediately following operation 1 in the predetermined hierarchical sequence of operations. Operation 3 is an operation immediately following operation 2 in the predetermined hierarchical sequence of operations.

For example, user 70 wishes to execute an operation such as generating a “nickname”. To create a nickname for a data source, existence of the following objects is required: a wrapper, a server definition, and a user mapping. A hierarchical relationship exists between the required objects. Creation of the wrapper requires a server definition; creation of the server definition requires a user mapping. Once the required objects are created or in place, the nickname can be created. At each step in a predetermined hierarchical sequence of operations for generating the nickname, system 10 gives user 70 an option of executing the operation or selecting an existing object. User 70 may request that system 10 create, for example, a new wrapper or may use an existing wrapper found by system 10.

Once a wrapper is selected or created, system 10 gives user 70 an option to select or create a server definition. User 70 may have selected a wrapper for which a server definition has already been created. In this case, user 70 can use that server definition. Otherwise, user 70 can direct system 10 to create another server definition. System 10 creates the server definition and proceeds to the next operation, creating the user mapping.

In one embodiment, system 10 uses SQL as an application programming interface (API) to determine whether objects required in the predetermined hierarchical sequence exist. System 10 also uses SQL to retrieve a list of existing objects and attributes for the existing objects. System 10 can use these objects in the predetermined hierarchical sequence to create the desired object.

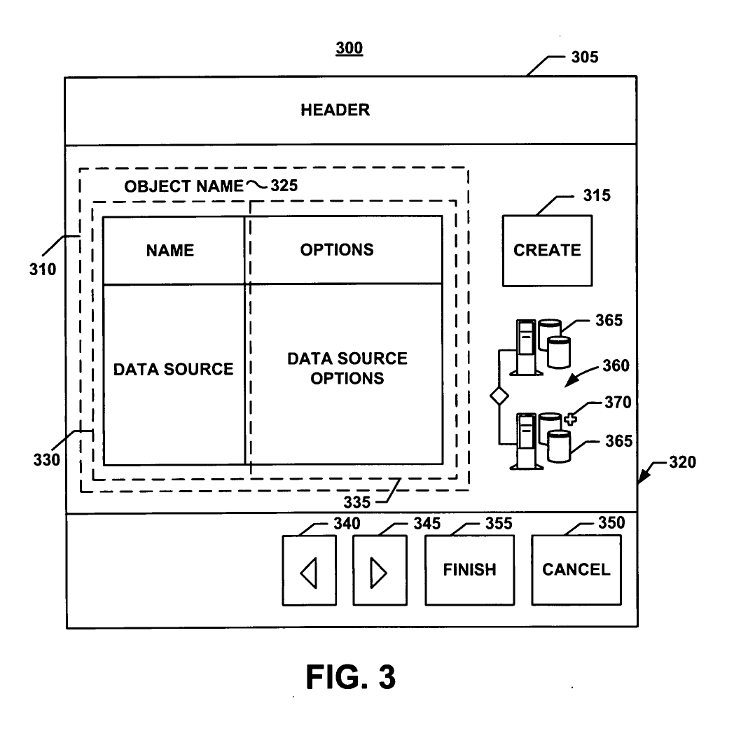

FIG. 3 illustrates an exemplary graphical user interface (GUI) screen 300 for use by system 10 in interacting with user 70. The GUI screen 300 reflects a current state of system 10. The GUI screen 300 comprises a header 305, an object window 310, a “create” button 315, and a navigation interface 320. The header 305 comprises information and instructions for user 70 regarding the currently displayed step in the predetermined hierarchical sequence.

The object window 310 comprises the object name 325 for the object associated with the currently displayed step in the predetermined hierarchical sequence. For example, when creating a nickname, the object name 325 may be “server definition”, “wrapper”, or “user mapping”, depending on the currently displayed step in the predetermined hierarchical sequence. The object window 310 further comprises a name column 330 and an options column 335. The name column 330 lists data sources where the associated object can be found. The options column 335 lists options or attributes for each of the associated data sources.

The create button 315 is selected by user 70 to initiate a create operation for the desired object associated with the currently displayed step in the predetermined hierarchical sequence.

The navigation interface 320 comprises navigation tools such as a back button 340, a forward button 345, a cancel button 350, and a finish button 355. The back button 340 allows user 70 to move one step back in the predetermined hierarchical sequence. The forward button 345 allows user 70 to move one step forward in the predetermined hierarchical sequence. The cancel button 350 allows user 350 to cancel operations by system 10. The cancel button 350 allows user 70 to interrupt the operation of the present system at the currently displayed step in the predetermined hierarchical sequence. User 70 can navigate back to a previously interrupted step in the predetermined hierarchical sequence by using the forward button 345 on the GUI screen 300. Alternatively, user 70 can repeat steps prior to the previously interrupted step, selecting or creating objects as desired.

A graphic 360 illustrates the object being created in the currently displayed step. In the exemplary GUI screen 300, a sub-graphic 365 illustrates a server and databases, showing user 70 that the currently displayed step applies to a server definition. A plus sign 375 shows user 70 that a server definition is being added.

It is to be understood that the specific embodiments of the invention that have been described are merely illustrative of certain applications of the principle of the present invention. Numerous modifications may be made to the system and method for managing and relating a predetermined hierarchical set of autonomous and dependent operations in a user interface described herein without departing from the spirit and scope of the present invention. Moreover, while the present invention is described for illustration purpose only in relation to objects and, more specifically, nicknames, it should be clear that the invention is applicable as well to, for example, any resource.

What is claimed is:

1. A method of completing a predetermined sequence of tasks to achieve an end goal, comprising:
initiating a task;
setting a resource associated with the task by:
determining whether a resource required to execute the task has been previously created;
if the resource has been previously created, providing a user with an option to either use the previously created resource or to create a new resource;
if the resource has not been previously created, creating a new resource; and
iteratively initiating one or more subsequent tasks by selectively using the resource associated with one or more previous tasks and setting a subsequent resource associated with the one or more subsequent tasks, until the end goal is achieved.

2. The method of claim 1, further comprising presenting the user with a graphical interface that reflects a current state of the predetermined sequence of tasks.

3. The method of claim 2, wherein the graphical interface allows the user to resume the sequence of tasks subsequent to an interruption in the execution of the sequence of tasks.

4. The method of claim 2, wherein the graphical interface allows the user to initiate the sequence of tasks.

5. The method of claim 2, wherein the graphical interface allows the user to set the resources associated with the sequence of tasks.

6. The method of claim 1, wherein determining whether the resource required to execute the task has been previously created comprises using an SQL as an application programming interface.

7. The method of claim 6, wherein using the SQL comprises retrieving a list of one or more existing resources and attributes for the one or more existing resources.

8. A computer program product having a plurality of executable instruction codes on a medium, for completing a predetermined sequence of tasks to achieve an end goal, comprising:
a first set of instruction codes for initiating a task;
a second set of instruction codes for setting a resource associated with the task comprising:
a first subset of instruction codes for determining whether a resource required to execute the task has been previously created;
if the resource has been previously created, a second subset of instruction codes provides a user with an option to either use the previously created resource or to create a new resource;
if the resource has not been previously created, a third subset of instruction codes creates a new resource; and
a third set of instruction codes for iteratively initiating one or more subsequent tasks by selectively using the resource associated with one or more previous tasks and setting a subsequent resource associated with the one or more subsequent tasks, until the end goal is achieved.

9. The computer program product of claim 8, further comprising a fourth set of instruction codes for presenting the user with a graphical interface that reflects a current state of the predetermined sequence of tasks.

10. The computer program product of claim 9, wherein the graphical interface allows the user to resume the sequence of tasks subsequent to an interruption in the execution of the sequence of tasks.

11. The computer program product of claim 9, wherein the graphical interface allows the user to initiate the sequence of tasks.

12. The computer program product of claim 9, wherein the graphical interface allows the user to set the resources associated with the sequence of tasks.

13. The computer program product of claim 8, wherein the first subset of instruction codes determines whether the resource required to execute the task has been previously created by using an SQL as an application programming interface.

14. The computer program product of claim 13, wherein the first subset of instruction codes uses the SQL to retrieve a list of one or more existing resources and attributes for the one or more existing resources.

15. A system for completing a predetermined sequence of tasks to achieve an end goal, comprising:
a sequential task execution system that initiates a task and that further sets a resource associated with the task by:
determining whether a resource required to execute the task has been previously created;
if the resource has been previously created, providing a user with an option to either use the previously created resource or to create a new resource;
if the resource has not been previously created, creating a new resource; and
the sequential task execution system iteratively initiating one or more subsequent tasks by selectively using the resource associated with one or more previous tasks and setting a subsequent resource associated with the one or more subsequent tasks, until the end goal is achieved.

16. The system of claim 15, further a graphical user interface that reflects a current state of the predetermined sequence of tasks.

17. The system of claim 16, wherein the graphical user interface allows the user to resume the sequence of tasks subsequent to an interruption in the execution of the sequence of tasks.

18. The system of claim 16, wherein the graphical user interface allows the user to initiate the sequence of tasks.

19. The system of claim 16, wherein the graphical user interface allows the user to set the resources associated with the sequence of tasks.

20. The system of claim 15, wherein the sequential task execution system determines whether the resource required to execute the task has been previously created by using an SQL as an application programming interface.
